(19) United States
(12) Patent Application Publication
(10) Pub. No.: US 2024/0114421 A1
(43) Pub. Date: Apr. 4, 2024

(54) MULTIPLE SECONDARY CELL GROUP CONFIGURATION

(71) Applicant: QUALCOMM Incorporated, San Diego, CA (US)

(72) Inventors: Punyaslok PURKAYASTHA, San Diego, CA (US); Ozcan OZTURK, San Diego, CA (US)

(21) Appl. No.: 18/477,345

(22) Filed: Sep. 28, 2023

Related U.S. Application Data
(60) Provisional application No. 63/378,036, filed on Sep. 30, 2022.

(51) Int. Cl. H04W 36/36; H04W 12/041; H04W 36/00

(52) U.S. Cl. CPC H04W 36/362; H04W 12/041; H04W 36/0058

(57) ABSTRACT

A UE receives a first primary cell group (MCG) configuration and a first secondary cell group (SCG) configuration; and receives a set of conditional secondary cell group (SCG) configurations, each conditional SCG configuration including a set of candidate target primary secondary cells (PSCells), corresponding PSCell change execution conditions, and corresponding SCG configurations. The UE communicates with a network, in response to an PSCell change execution condition corresponding to a first PSCell being satisfied, based on the first MCG configuration, the first SCG configuration, and an SCG configuration corresponding to the first PSCell.

### CROSS REFERENCE TO RELATED APPLICATION(S)

This application claims the benefit of and priority to U.S. Provisional Application Ser. No. 63/378,036, entitled “Multiple Secondary Cell Group Configuration” and filed on Sep. 30, 2022, which is expressly incorporated by reference herein in its entirety.

### TECHNICAL FIELD

The present disclosure relates generally to communication systems, and more particularly, to wireless communication include a secondary cell group (SCG) configuration.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided for wireless communication at a user equipment (UE). The apparatus receives a first primary cell group (MCG) configuration and a first secondary cell group (SCG) configuration; and receives a set of conditional secondary cell group (SCG) configurations, each conditional SCG configuration including a set of candidate target primary secondary cells (PSCells), corresponding PSCell change execution conditions, and corresponding SCG configurations. The apparatus communicates with a network, in response to an PSCell change execution condition corresponding to a first PSCell being satisfied, based on the first MCG configuration, the first SCG configuration, and an SCG configuration corresponding to the first PSCell.

In an aspect of the disclosure, a method, a computer-readable medium, and an apparatus are provided for wireless communication at a primary node (MN). The apparatus receives from one or more target secondary nodes (SNs), a set of candidate target PSCells, each PSCell in the set associated with a SCG configuration. The apparatus provides, to a UE, a first MCG configuration and a first SCG configuration. The apparatus provides, to the UE, a set of conditional SCG configurations, each conditional SCG configuration including a combined set of candidate target PSCells, corresponding PSCell change execution conditions, and corresponding SCG configurations, the combined set of candidate target PSCells being based on the set of candidate target PSCells received from the one or more target SNs.

In an aspect of the disclosure, a method, a computer-readable medium, and an apparatus are provided for wireless communication at an SN. The apparatus receives an SN addition request for a UE from a MN for the UE and including a first SCG configuration; and sends, to the MN in response to the SN addition request, a set of candidate target PSCells for the UE and a set of SCG configurations including a corresponding SCG configuration for each of the candidate target PSCells.

To the accomplishment of the foregoing and related ends, the one or more aspects comprise the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is an example communication flow in accordance with various aspects of the present disclosure.

FIG. 5 is an example communication flow in accordance with various aspects of the present disclosure.

FIG. 6 is an example communication flow in accordance with various aspects of the present disclosure.

FIG. 7 is an example communication flow in accordance with various aspects of the present disclosure.

FIG. 8 is a flowchart of a method of wireless communication in accordance with various aspects of the present disclosure.

FIG. 9 is a flowchart of a method of wireless communication in accordance with various aspects of the present disclosure.

FIG. 10 is a flowchart of a method of wireless communication in accordance with various aspects of the present disclosure.

FIG. 11 is a diagram illustrating an example of a hardware implementation for an example apparatus and/or UE in accordance with various aspects of the present disclosure.

FIG. 12 is a diagram illustrating an example of a hardware implementation for an example network entity in accordance with various aspects of the present disclosure.

### DETAILED DESCRIPTION

To improve mobility for wireless communication, a UE may be provided with configurations to perform a sequence of PSCell changes without being reconfigured after each PSCell change. The configurations, e.g., for the sequence of PSCell changes, may be conditional configurations, and the procedures for configuration may improve upon conditional PSCell addition or change procedures (CPA/CPC). Such conditional configurations may be referred to as multiple SCG (multi-SCG) configurations. As presented herein, base secondary cell group (SCG) and primary cell group (MCG) configurations may be provided to the UE, as well as delta configurations with respect to the base configurations. A base configurations may also be referred to by others names, such as a reference configuration. For example, one or more of the multi-SCG configurations may be based on a delta with respect to the base configuration, e.g., as a reference configuration. Aspects presented herein provide for security handling at the UE and the network in connection with the PScell change procedures.

The detailed description set forth below in connection with the drawings describes various configurations and does not represent the only configurations in which the concepts described herein may be practiced. The detailed description includes specific details for the purpose of providing a thorough understanding of various concepts.

However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer. While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

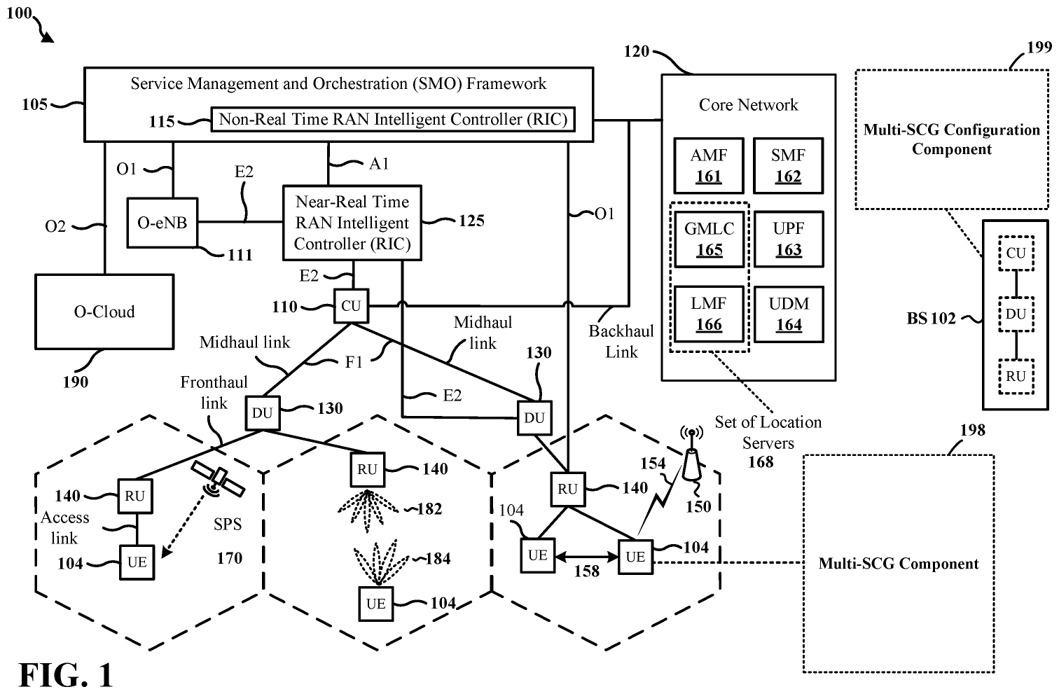

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140. Each of the units, i.e., the CUs 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit—User Plane (CU-UP)), control plane functionality (i.e., Central Unit—Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an Al interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via O1) or via creation of RAN management policies (such as Al policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNB s), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in some aspects, the UE 104 may include a multi-SCG component 198 that is configured to receive a first MCG configuration and a first SCG configuration; receive a set of conditional SCG configurations, each conditional SCG configuration including a set of candidate target PSCells, corresponding PSCell change execution conditions, and corresponding SCG configurations; and communicate with a network, in response to an PSCell change execution condition corresponding to a first PSCell being satisfied, based on the first MCG configuration, the first SCG configuration, and an SCG configuration corresponding to the first PSCell.

In some aspects, the base station 102 may include a multi-SCG configuration component 199. In some aspects, such as when operating as an MN, the multi-SCG component 199 may be configured to receive from one or more target SNs, a set of candidate target PSCells, each PSCell in the set associated with a SCG configuration; provide, to a UE, a first MCG configuration and a first SCG configuration; and provide, to the UE, a set of conditional SCG configurations, each conditional SCG configuration including a combined set of candidate target PSCells, corresponding PSCell change execution conditions, and corresponding SCG configurations, the combined set of candidate target PSCells being based on the set of candidate target PSCells received from the one or more target SNs.

In some aspects, such as when operating as an SN, the multi-SCG component 199 may be configured to receive an SN addition request for a UE from a MN for the UE and including a first SCG configuration; and send, to the MN in response to the SN addition request, a set of candidate target PSCells for the UE and a set of SCG configurations including a corresponding SCG configuration for each of the candidate target PSCells.

Although the following description may be focused on 5G NR, the concepts described herein may be applicable to other similar areas, such as LTE, LTE-A, CDMA, GSM, and other wireless technologies.

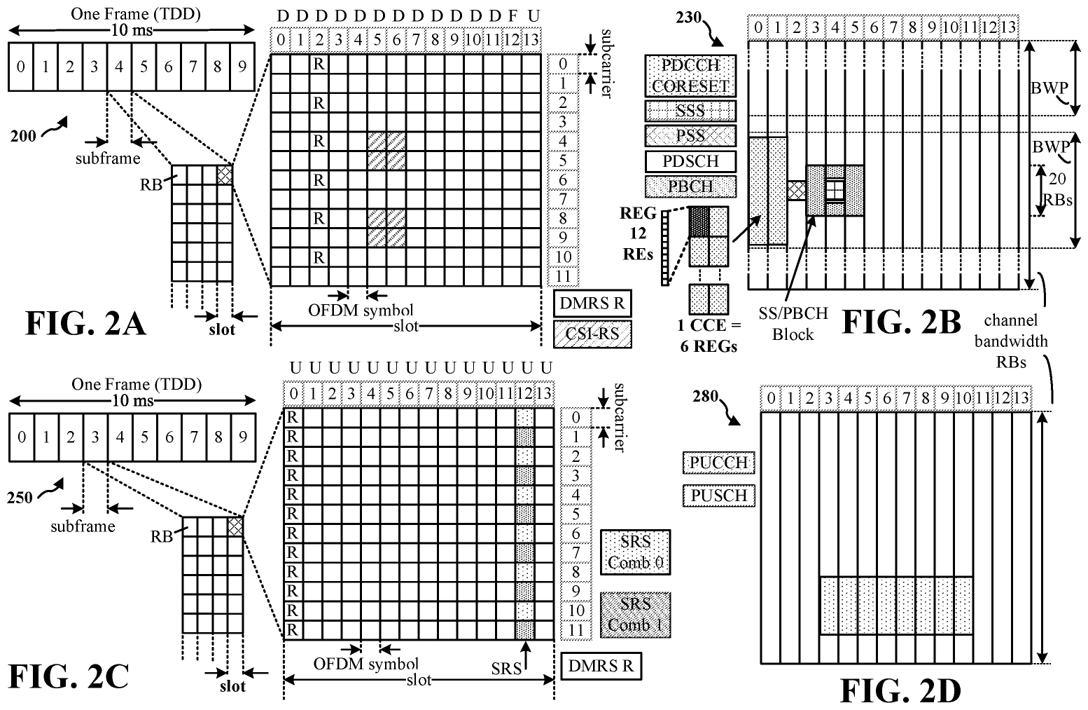

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1(with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | Cyclic |
|---|---|---|
| μ | Δƒ = 2^{μ} · 15[kHz] | prefix |
| 0 | 15 | Normal |
| 1 | 30 | Normal |
| 2 | 60 | Normal, |
| | | Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2 g slots/subframe. The subcarrier spacing may be equal to 2^{μ}* 15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (B SR), a power headroom report (PHR), and/or UCI.

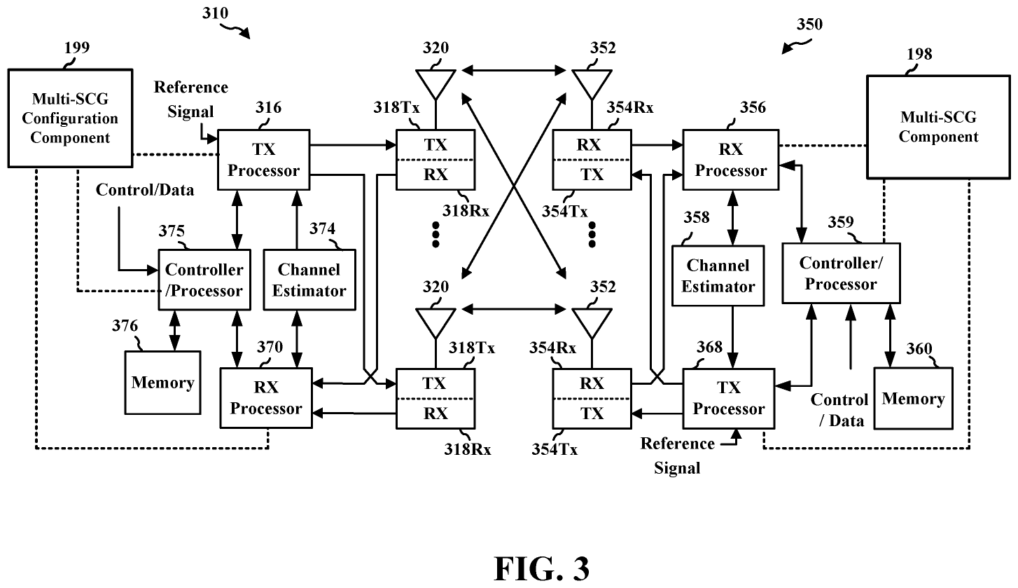

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIB s), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with at least one memory 360 that stores program codes and data. The at least one memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIB s) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with at least one memory 376 that stores program codes and data. The at least one memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the multi-SCG component 198 of FIG. 1.

At least one of the TX processor 316, the RX processor 370, and the controller/processor 375 may be configured to perform aspects in connection with the multi-SCG configuration component 199 of FIG. 1.

In some aspects, a UE may receive a multi-radio dual connectivity (MR-DC) configuration with a primary cell group (MCG) (which may also be referred to as a master cell group) and a secondary cell group (SCG). The UE may be mobile, and performs measurements of a serving cell and other cells. The UE measurements may be used to determine when to change the UE to service by a different cell.

To improve mobility for wireless communication, a UE may be provided with configurations to perform a sequence of PSCell changes without being reconfigured after each PSCell change. The configurations may enable the UE to move to service with a different PSCell with greater efficiency and reduced latency. The configurations, e.g., for the sequence of PSCell changes, may be conditional configurations, and the procedures for configuration may improve conditional PSCell addition (CPA) procedure or conditional PSCell change (CPC) procedures. Such conditional configurations may be referred to as multiple SCG (multi-SCG) configurations. As presented herein, base SCG and MCG configurations may be provided to the UE, as well as delta configurations with respect to the base configurations. For example, one or more of the multi-SCG configurations may be based on a delta with respect to the base configuration. Aspects presented herein provide for security handling at the UE and the network in connection with the PSCell change procedures.

As presented herein, a UE may keep the source configurations and the conditional configurations provided by the network after a PSCell change, unless indicated otherwise to the UE by the network. By keeping the source configurations and the conditional configurations, the UE is enabled to perform a sequence of PSCell changes without network reconfiguration after every cell change. This reduces the amount of time and overhead for the UE to make the PSCell change, which can improve communication with the network and reduce latency for such cell changes.

In some aspects, a primary node (MN) may determine the execution conditions for the procedure, e.g., for the sequence of PSCell changes. In other aspects, a secondary node (SN) may determine the execution conditions for the procedure, e.g., for the sequence of PSCell changes.

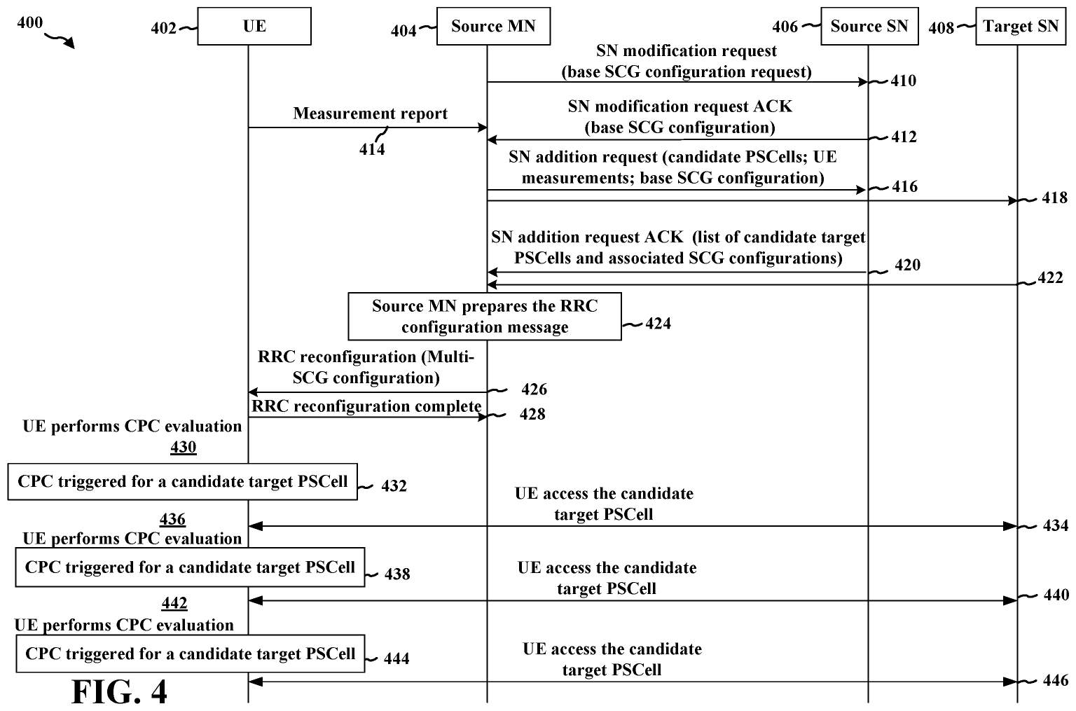

FIG. 4 illustrates an example signaling flow 400 for an MN initiated procedure (e.g. preparation procedure) for multi-SCG configuration for a UE 402. This CPC procedure includes a change of SN, e.g., from a source SN to a target SN. An MN initiated procedure refers to a procedure in which the MN determines the execution conditions for the sequence of PSCell changes for the UE. FIG. 4 illustrates a communication flow between various entities including a source MN 404, a source SN 406, and a target SN 408 for the UE 402. As illustrated at 410, a UE 402 provides a measurement report to a source MN 404 (e.g., a current serving MN). The MN may be referred to herein as a primary node. In some aspects, an MN may be referred to as a master node. The MN may be associated with a primary cell group, e.g., which may be referred to as a master cell group (MCG). The MCG may include a PCell. The SN may be associated with a secondary cell group (SCG), and may include a PSCell. The UE may be configured for communication with the MN 404 and SN 406 (e.g., a source SN). In FIG. 4, the UE continues to be served by the source MN 404, and changes from communication via the source SN 406 to communication via the target SN 408. In some aspects a target SN may be referred to as a T-SN.

The source MN may obtain, from a source SN, a base SCG configuration to be used for the preparation procedure. At 410, the source MN 404 sends a request to the source SN 406 to initiate the procedure. The request 410 may be referred to as an SN modification request including a base SCG configuration request, etc. At 412, the source SN 406 responds to the MN's request with an acknowledgement, e.g., which may be referred to as an SN modification request ACK, and which may include the base SCG configuration, e.g., which may also be referred to by other names such as a reference configuration. As illustrated, the source SN 406 may determine the base SCG configuration to be used for the procedure and provide it to the source MN 404. An SN modification procedure can be used for this purpose, e.g., to obtain the base SCG via an SN modification request and SN modification request ACK.

As illustrated at 414, the source MN 404 may receive one or more measurement reports from the UE 402. The UE may perform measurements of reference signals from one or more cells, and may provide the measurement report based on the measurements. The measurement report may include a reference signal received power (RSRP), a reference signal received quality (RSRQ), or a Signal to Interference and Noise Ratio (SINR) report based on received reference signals from the cells. The measurement report may be based on the UE's measurement of reference signals such as SSBs and/or CSI-RS s from the cells.

The source MN 404 may provide the base SCG configuration to a target SN 408 in an SN addition procedure. As shown at 416 and 418, the source MN 404 may send an SN addition request to the source SN 406 and the target SN 408. The request may include a set of candidate PSCells, the UE measurements, e.g., obtained at 414, and the base SCG configuration received from the source SN 406 at 412. As shown at 420 and 422, the source SN 406 and the target SN 408 may respond with an SN addition request ACK that includes a list of candidate target PSCells (which may be a set of PSCells from the list provided in the SN addition request) and an associated SCG configuration for each of the candidate target PSCells. The SCG configuration associated with each candidate target PSCell in the SN addition request ACK (e.g., at 402 and 422) may be a delta configuration with respect to the base SCG configuration, e.g., the SCG configurations of the candidate target PSCells may indicate differences with respect to the base SCG configuration without repeating indications of the configuration aspects that are in common with the base SCG configuration.

In some aspects, the target SN 408 may respond with SCG configurations that indicate a delta relative to the base SCG configuration and/or may indicate a full SCG configuration (that is independent of the base SCG configuration) for the candidate target PSCells. The target SN 408 may include an indication in the SN addition request ACK 422 for each candidate target PSCell, denoting whether the associated SCG configuration is a delta with respect to the base SCG configuration. Without the indication, or with an indication that the SCG configuration is not a delta, the source MN may determine that the SCG configuration for one or more of the candidate target PSCells is not a delta with respect to the base SCG configuration.

At 424, the source MN 404 may prepare an RRC configuration message for the UE 402 based on the candidate target PSCells and associated SCG configurations received from the source SN 406 and/or target SN(s) 408. Although the source MN's request and response with a single target SN 408 is shown to illustrate the concept, the source MN 404 may send an SN addition request 418 to multiple target SNs and may receive a set of candidate target PSCells and corresponding SCG configurations from multiple target SNs.

At 426, the source MN 404 transmits the RRC reconfiguration message to the UE 402, the RRC reconfiguration message containing the multi-SCG configuration. The RRC reconfiguration message 426 may include the base SCG and MCG configurations, as well as indications for each candidate target PSCell in the multi-SCG configuration, denoting whether the associated SCG and MCG configurations are delta configurations with respect to the base configurations.

For example, the multi-SCG configuration may include:
(1) A base SCG configuration,
(2) A base MCG configuration,
(3) A conditional PSCell change (CPC) configuration including a set of candidate target PSCells, execution conditions (e.g., which may be referred to as PSCell change execution conditions) for accessing the candidate target PSCells, and the SCG and MCG configurations associated with each candidate target PSCell,
(4) For each cell in the CPC configuration in 3), a set of candidate target PSCells, and associated execution conditions and SCG and MCG configurations with each such candidate target PSCell, and/or
(5) For each cell in the CPC configuration in 4), a set of candidate target PSCells, and associated execution conditions and SCG and MCG configurations with each such candidate target PSCell.

As shown by information (4) and (5) that is included in the RRC reconfiguration, the configuration enables the UE to perform a sequence of PS Cell changes. For example, once the UE changes to a second PSCell using the configuration information in (3), the UE uses the set of target PSCells and execution conditions from (4) for that second PSCell. Similarly, once the UE changes to a third PSCell using the information in (4), the UE uses the set of target PSCells and execution conditions from (5) that correspond to the third PSCell. Although the example illustrates information (4) and (5), the multi-SCG configuration may include any number of cascading sets of candidate target PSCells and execution conditions that are associated with the prior level of candidate target PSCells in the sequence. For example, the multi-SCG configuration may include a set of information (6) with reference to each of the candidate target PSCells from (5), a set of information (7) with reference to each of the candidate target PSCells from (6), and so forth.

The execution conditions in the multi-SCG configuration (at 426) may be indicated with, or associated with, measurement IDs that correspond to a source MCG measurement configuration. For example, the execution conditions may reference a source MCG measurement configuration by indicating the corresponding measurement ID. An example of an execution condition may be that a measurement (such as an reference signal received power (RSRP) measurement) for a candidate target PSCell is greater than a corresponding measurement for the source PSCell plus a threshold amount. In some aspects, the execution condition may further include that the measurement remain above the source PSCell measurement by the threshold amount for a period of time in order to trigger the change to the candidate target PSCell.

The source MN 404 may determine a base MCG configuration to be used for the procedure. The MCG configuration (e.g., in (3), (4), and (5)) associated with each candidate target PSCell may be a delta with respect to the base MCG configuration.

FIG. 4 illustrates that the UE may confirm receipt of the reconfiguration, at 428, with an RRC reconfiguration complete message.

At 430, the UE performs a CPC evaluation based on the execution conditions received in the RRC reconfiguration. For example, the UE may evaluate each of the candidate target PSCells (e.g., of the first level of the sequence, based on the information (3) above) and the corresponding PSCell change execution conditions. For example, the UE may compare measurements for each of the candidate target PSCells indicate in (3) to measurements of the current source PSCell for the UE. At 432, a PSCell change is triggered based on an execution condition for one of the candidate target PSCells being satisfied. The candidate target PSCell may be referred to as a second PSCell. At 434, the UE accesses the second candidate target PSCell, e.g. changes from the prior PSCell to communication via the second PSCell. The UE may apply the MCG and SCG configurations for the second PSCell, which were provided to the UE in the multi-SCG configuration (e.g., 426) in information (3). As described above, the SCG and MCG configurations for the second PSCell may be a delta with respect to a base SCG and MCG configuration. The UE then performs the CPC evaluation, at 436, based on the information at (4) corresponding to the second PSCell. For example, at (4), the multi-SCG configuration includes a set of candidate target PSCells and corresponding execution conditions for the UE to consider in response to a change to the second PSCell. The information at (4) may include sets of candidate target PSCells and corresponding execution conditions for each of the candidate target PSCells from (3). Therefore, depending on the change to any of multiple candidate target PSCells indicated for the UE to consider at (3), the UE has the following configuration information to consider for the next CPC in the sequence.

The UE 402 may keep, e.g., maintain, store, etc., the base SCG and MCG configurations after each CPC trigger. As an example, the UE may keep, e.g., maintain, store, continue to consider, the configurations based upon a network indication to the UE maintain the configurations after a CPC trigger. For example, upon accessing a candidate target PSCell for which CPC is triggered, UE may keep the base SCG and/or the base MCG configurations based upon network indications that these should be kept after the CPC trigger.

Upon accessing a candidate target PSCell (e.g., the second PSCell) for which the CPC is triggered (e.g., based on the corresponding execution condition being satisfied), the UE initiates an evaluation of the CPC corresponding to this candidate target PSCell (e.g., the second PSCell), at 436, e.g., using the information in (4) from the multi-SCG configuration described above. At 438, a CPC may be triggered for a candidate target PSCell (e.g., a third PSCell) from the set provided for the second PSCell. At 440, the UE access the new candidate target PSCell, e.g., the third PSCell, and communicates via the new PSCell rather than the second PSCell. The UE may apply the MCG and SCG configurations for the third PSCell, e.g., from the information (4) in the multi-SCG configuration, which may include delta information relative to the base MCG and SCG configurations.

Upon accessing the candidate target PSCell (e.g., the third PSCell) for which the CPC is triggered (e.g., based on the corresponding execution condition being satisfied), the UE initiates an evaluation of the CPC corresponding to this candidate target PSCell (e.g., the third PSCell), at 442, e.g., using the information in (5) from the multi-SCG configuration described above. At 444, an additional CPC may be triggered for a candidate target PSCell (e.g., a fourth PSCell) from the set indicated for evaluation in connection with the third PSCell. At 446, the UE access the new PSCell (e.g., the fourth PSCell) using the corresponding MCG and SCG configurations indicated in the information (5) in the multi-SCG configuration, which may be a delta relative to the base MCG and base SCG configurations. Although an example of three levels of CPC evaluation is illustrated, the multi-SCG configuration in the RRC reconfiguration message 426 may provide any number of levels of CPC information. This enables the UE to perform a sequence of PSCells changes and to evaluation a following PSCell change without reconfiguration by the network after each PSCell change.

In some aspects, the source MN 404 may update the execution conditions at a later point in time, e.g., after a PSCell change for the UE. The source MN 404 may indicate, to the UE 402, the new MCG measurement configuration by indicating a corresponding set of measurement IDs to the UE.

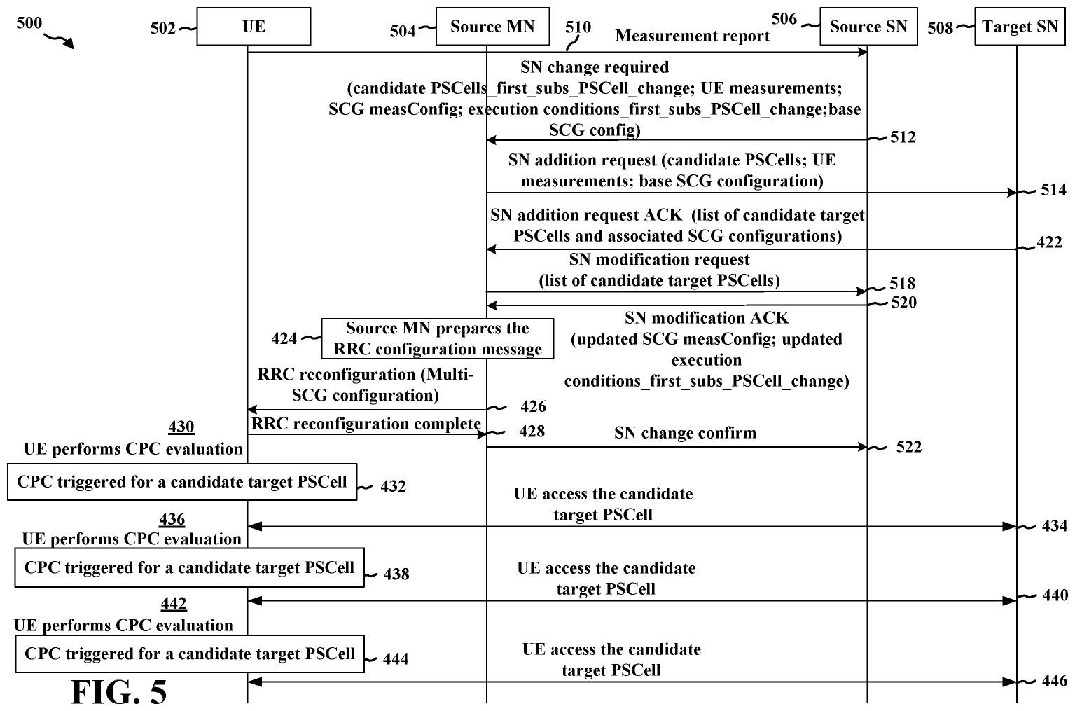

FIG. 5 illustrates an example communication flow 500 for a source SN initiated procedure for multi-SCG configuration, e.g., in which the source SN determines the execution conditions. FIG. 5 illustrates that the source SN 506 may receive the measurement report 510 from the UE 502, e.g., in contrast to FIG. 4 in which the report is received by the source MN 404. In FIG. 5, the source SN 506 initiates the preparation procedure. If an SN change is triggered, e.g., based on the measurement report from the UE 502, the source SN 506 may indicate, at 512, to the source MN 504 that an SN change is to occur. The indication may include: a set of candidate PSCells (e.g., which may be referred to as PSCells_first_subs_PSCell_change) and may be identified by candidate PSCell IDs for a first and each subsequent PSCell change, a set of target SN IDs for the first and each subsequent PSCell change, execution conditions for the first and each subsequent PSCell change, a base SCG configuration, an indication of a selective activation procedure.

In some aspects, the execution conditions may be indicated with measurement IDs that correspond to the source SCG measurement configuration.

The source MN 504 then transmits an SN addition request 418 to the target SN 508, e.g., in the same manner as described in connection with FIG. 4, and the target SN responds with the SN addition request ACK 422.

At 518, the source MN 504 may provide an SN modification request 518 with a list of candidate target PSCells to the source SN 506, to which the source SN 506 may reply with an SN modification request ACK 520 that indicates an updated SCG measurement configuration, e.g., which may provide updated execution conditions. This allows the source SN 506 to provide updated execution conditions to the source MN 504 after receiving information regarding the candidate target PSCells prepared by the target SN(s) 508.

The source SN 506 may also provide an updated source SCG measurement configuration to the MN after receiving information regarding the candidate target PSCells prepared by the target SN(s) 508. This is because the candidate target PSCells may be a subset of the candidate PSCells proposed by source SN to the target SNs, so that a more optimized source SCG measurement gap configuration may be provided.

The preparation and transmission of RRC reconfiguration message 426 that the source MN 504 provides to the UE 502 with the multi-SCG configuration may include similar information as described in connection with FIG. 4, and the evaluation and access to the different target PSCells corresponds to the aspects described in connection with FIG. 4 and are shown with the same reference numbers as the corresponding aspects of FIG. 4. As with FIG. 4, there may be multiple target SNs involved in the procedure, and the interaction of the target SN 508 shows the aspects that may be performed by any number of target SNs that receive a request 514. The source MN 504 may confirm the SN change to the source SN 506, e.g., as illustrated at 522.

In some aspects, a UE may receive an indication from a network to perform a PSCell change, while the UE is performing a CPC evaluation. For example, the UE may receive a command to change a PSCell rather than the change being indicated by an execution condition of the multi-SCG configuration being satisfied. The command may be referred to as a legacy command, in some aspects, to distinguish from a conditional PSCell change based on the multi-SCG configuration.

If the UE received the PSCell change command while the UE is performing a CPC evaluation, the UE may perform the PSCell change indicated in the command. In some aspects, the UE may keep the source and the conditional configurations. In some aspects, the UE may keep the source and conditional configurations based on a network indication in the PSCell change command. The UE may initiate CPC evaluation on the target PSCell based on a network indication in the PSCell change command.

In some aspects, the UE may receive an SCG release command while the UE is performing a CPC evaluation based on the multi-SCG configuration. In response to receiving the SCG release command, the UE may discard the multi-SCG configuration in addition to the source SCG configuration.

As part of a security mechanism, upon initiating the SN addition procedure (e.g., at 416, 418), the source MN 404 or 504 derives a key K_{SN} to be used for communication between the UE and the SN, e.g., to be used for bearers terminated in the SN. The key is derived based on the MN key K_{MN} and an SN counter variable.

K_{SN}=KDF (K_{MN}, SN Counter), where KDF denotes the key derivation function.

The SN Counter may be an integer between 0 and 65535. The MN may keep the SN Counter and transmit K_{SN} to the SN in the SN addition request. The MN may provide the SN Counter to the UE in the MCG configuration as a part of the RRC reconfiguration message that the MN provides in the dual connectivity (DC) configuration to the UE.

The UE derives K_{SN} in a similar way as the MN, e.g., from K_{MN} and the provided SN Counter. From the derived K_{SN}, the UE computes the RRC and user plane (UP) keys to be used for the various bearers.

In some aspects, in the PSCell changes described herein, a UE may return back to a previous PSCell. The UE may use a different SN key than the UE previously used with the PSCell.

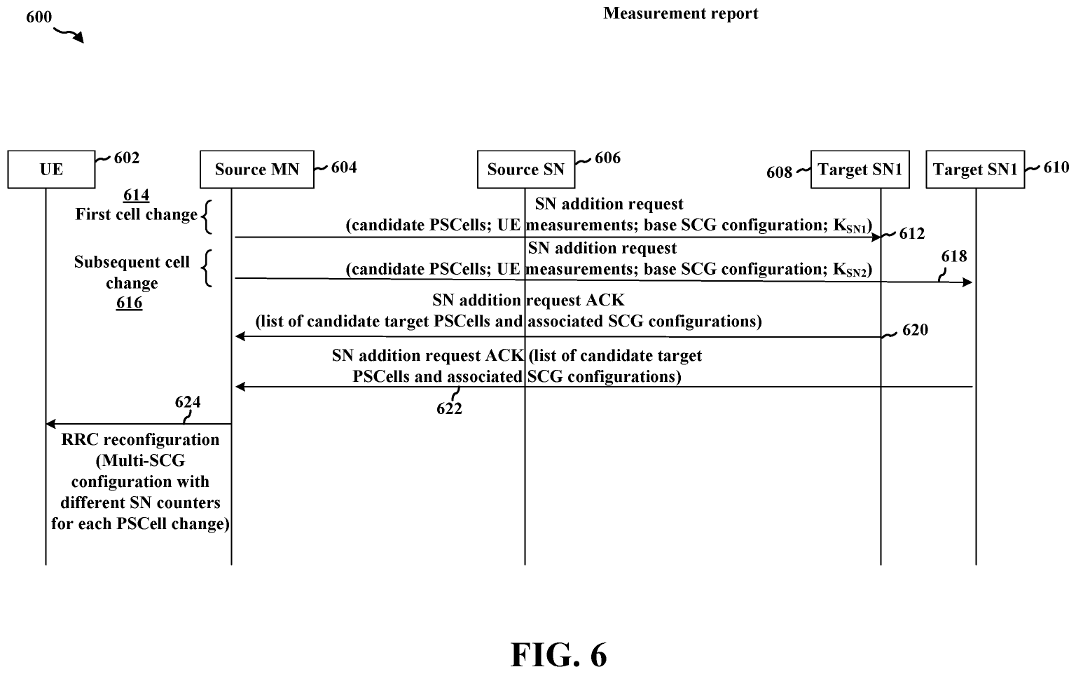

Different SN keys may be generated by the MN for the first and each subsequent PSCell change, e.g., as shown in FIG. 6. The corresponding SN Counters provided to the UE in the multi-SCG configuration are different for the first and each subsequent PSCell change. This enables the UE to use a different SN key after each PSCell change.

In order for a target SN to know which SN key to use as the UE moves, e.g., in case UE comes back to the previous cell, the target SN can identify the SN key based on the C-RNTI transmitted by the UE when the UE accesses a target SN. This is based on unique SCG C-RNTIs being provided during the procedure, and the C-RNTIs may be exhausted if there are many UEs in a cell. In another way, the SN may determine the key to use based on a new ID that the UE transmits when the UE accesses a target SN. The new IDs may be configured in the multi-SCG configuration.

For example, a set of new UE IDs may be provided in the multi-SCG configuration with unique IDs provided for each PSCell change. Whenever a UE accesses a target SN following an execution condition trigger, the UE transmits the ID to the target SN.

FIG. 6 illustrates a communication flow 600 in which a UE 602 is served by a source MN 604 and a source SN 606. At 614, a first cell change occurs (SN change is initiated) for the UE 602, and the source MN sends an SN addition request 612 to the target SN 608 with a list of candidate PSCells, UE measurements, and base SCG configuration, and a key K_{SN1}. At 616, a subsequent cell change occurs (e.g., an SN change is initiated), and the source MN sends a similar SN addition request 618 to the target SN 610. The SN addition request 618 includes a second key K_{SN2}. The target SNs 608 and 610 respond to the source MN with an SN addition request ACK 620 and 622 that includes a list of candidate target PSCells and associated SCG configurations, e.g., as described in connection with FIG. 4. At 624, the source MN 604 provides the UE 602 with an RRC reconfiguration 624, similar to the RRC reconfiguration described in connection with FIG. 4, and further including different SN counters for each PSCell change. As discussed above, the RRC reconfiguration 624 from the source MN 604 may provide the UE with a set of UE IDs to be used for PSCell changes, and the UE 602 may indicate an ID from the set of UE IDs to a target SN with changing PSCells. A different UE ID is used after each PSCell change, and is accordingly provided in the RRC reconfiguration.

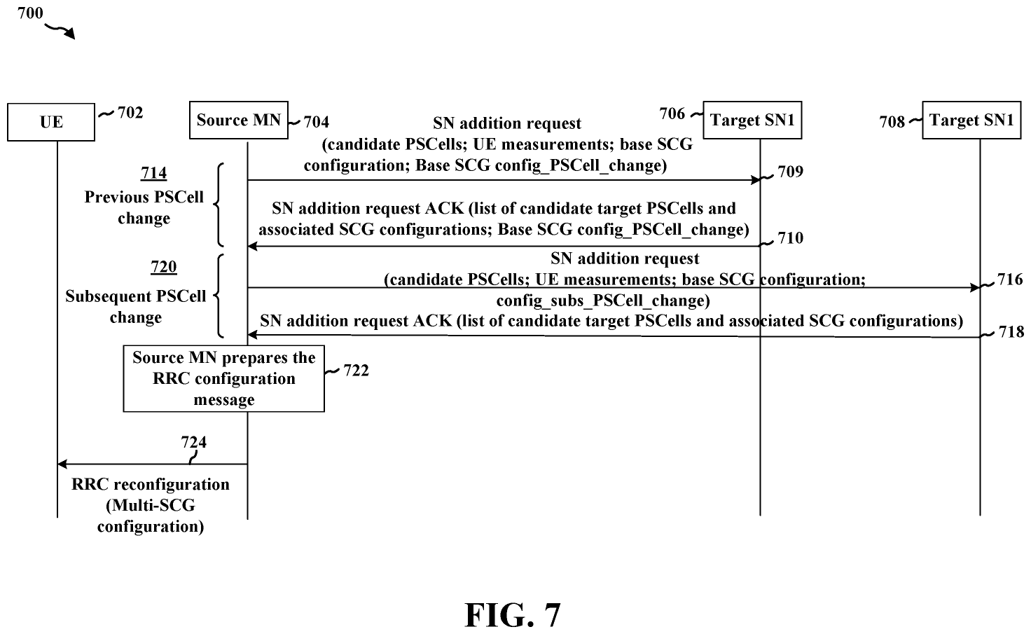

FIG. 7 illustrates an example communication flow 700 in which the base SCG configurations for subsequent PSCell changes may be provided by a target SN. FIG. 7 illustrates that a source MN 704 for a UE 702 may send an SN addition request 709 for a first (e.g., previous) PSCell change 714 to a target SN 706. The request may include a set of candidate target PSCells, UE measurements, and a base SCG configuration, e.g., as described in connection with FIG. 4. At 710, the target SN 706 may respond with an SN addition request ACK, e.g., as described in connection with FIG. 4, which may include a base SCG configuration. FIG. 7 shows a subsequent PSCell change 720 in which the source MN 704 sends an SN addition request 716 to a target SN 708. The request may include a set of candidate target PSCells, UE measurements, and the base SCG configuration that was received from the target SN 706. The target SN 708 responds with an SN addition request ACK 718, e.g., which includes a list of candidate target PSCells and associated SCG configurations. The source MN prepares the RRC message, at 722, and provides the multi-SCG configuration, e.g., as described in connection with FIG. 4, to the UE 702, at 724.

In FIG. 7, the base SCG configurations for a subsequent PSCell change may be provided by a target SN of the previous PSCell change. As an example, for all prepared PSCells in a target SN, the target SN may provide the same base SCG configuration.

The base SCG configurations for a subsequent PSCell change may be provided by a target SN during preparation of the previous PSCell change to the source MN. Source MN signals these base SCG configurations during preparation of the subsequent PSCell change to the corresponding target SNs.

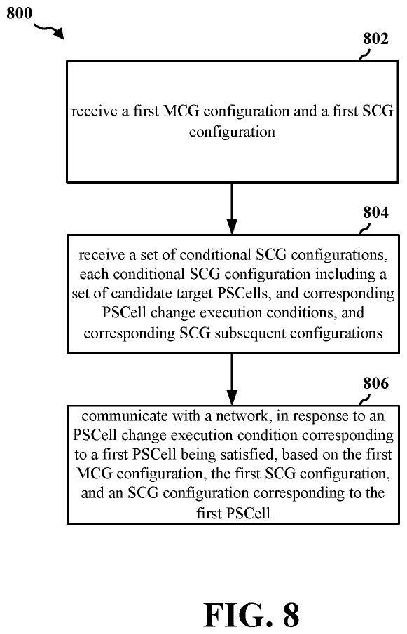

FIG. 8 is a flowchart 800 of a method of wireless communication. The method may be performed by a UE (e.g., the UE 104, 350, 402, 502, 602, 702; the apparatus 1104). Various aspects of the method may be performed, e.g., by the multi-SCG component 198 described in connection with FIG. 1, 3, and/or 11. The method helps to improve mobility for the UE enabling the UE to perform a sequence of PSCell changes without signaling to reconfigure the UE each time a change is made. Therefore, aspects can reduce latency and help to maintain continuity of service.

At 802, the UE receives a first MCG configuration and a first SCG configuration. In some aspects, the first MCG configuration and the first SCG configuration may be referred to as base MCG and SCG configurations. The first SCG configuration may be received from a source SN via a MN.

At 804, the UE receives a set of conditional SCG configurations, each conditional SCG configuration including a set of candidate target PSCells, corresponding PSCell change execution conditions, and corresponding SCG configurations. FIGS. 4-7 illustrate various example aspects of a UE receiving a multi-SCG configuration. For example, for a given PSCell in the set of candidate target PSCells, the conditional SCG configuration may include one or more PSCell change execution conditions and an SCG configuration. The set of conditional SCG configurations may include an associated MCG configuration and an associated SCG configuration for each candidate target PSCell, which indicates a delta relative to the first MCG configuration and the first SCG configuration, and the UE may communicate at 806 based on the first MCG configuration, the first SCG configuration, and the SCG configuration corresponding to the first PSCell includes applying the delta relative to the first MCG configuration and the first SCG configuration. The UE may receive the SCG configuration corresponding to a candidate target PSCell in the set of conditional SCG configurations from a target SN via the MN. Each PSCell change execution condition may be indicated by a measurement identifier with respect to a source MCG measurement configuration.

At 806, the UE communicates with a network, in response to an PSCell change execution condition corresponding to a first PSCell being satisfied, based on the first MCG configuration, the first SCG configuration, and an SCG configuration corresponding to the first PSCell.

For each given candidate target PSCell indicated at a first level, the set of conditional SCG configurations may further include: a group of candidate target PSCells, one or more PSCell change execution conditions corresponding to the given candidate target PSCell from the group of candidate target PSCells, a group of MCG configurations, and a group of SCG configurations for the UE to apply when the UE changes to the given candidate target PSCell from the group of candidate target PSCells.

In some aspects, the UE may evaluate, following a change to a candidate target PSCell from the group of candidate target PSCells, another group (which may also be referred to as an additional group) of candidate target PSCells and the one or more PSCell change execution conditions corresponding to a candidate target PSCell from the other group of candidate target PSCells (e.g., which may be referred to as an additional candidate target PSCell from the additional group of candidate target PSCells).

In some aspects, the UE may maintain (e.g., keep for further evaluation or not discard) the first MCG configuration, the first SCG configuration, and the set of conditional SCG configurations after a PSCell change.

In some aspects, the UE may receive a command for a PSCell change while evaluating the corresponding PSCell change execution conditions; perform the PSCell change in response to the command; and maintain the first MCG configuration, the first SCG configuration, and the set of conditional SCG configurations after performing the PSCell change. The command may include an indication to maintain the first MCG configuration, the first SCG configuration, and the set of conditional SCG configurations after performing the PSCell change.

In some aspects, the UE may receive a command from the network to release an SCG while evaluating the PSCell change execution conditions from the set of conditional SCG configurations; and discard the first SCG configuration and the set of conditional SCG configurations in response to the command.

In some aspects, the set of conditional SCG configurations may further include a set of IDs with one ID associated with each PSCell change. The UE may provide a corresponding ID to a target SN associated with the first PSCell in response to a change to the first PSCell; and using a key derived based on the corresponding ID for communicating with the first PSCell.

In some aspects, the set of conditional SCG configurations may include a set of key counters with a key counter associated with each PSCell change, and the UE may use a key derived based on a key counter associated with a PSCell change to the first PSCell for communicating with the first PSCell.

The method may further include any of the aspects performed by the UE in FIG. 4, 5, 6, and/or 7.

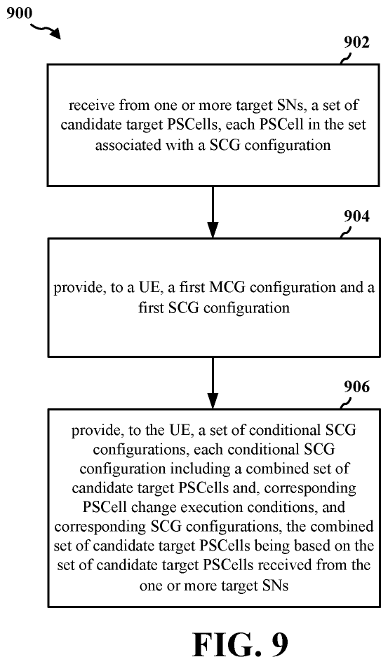

FIG. 9 is a flowchart 900 of a method of wireless communication. The method may be performed by a network node, such as an MN (e.g., the base station 102; 310; source MN 404, 504, 604, 704; the network entity 1202. Aspects may be performed by a network node that may correspond to a base station in aggregation and/or by one or more components of a base station, such as a CU 110, DU 130 and/or RU140. Various aspects of the method may be performed, e.g., by the multi-SCG component 199 described in connection with FIG. 1, 3, and/or 12. The method helps to improve mobility for a UE by providing information to enable the UE to perform a sequence of PSCell changes without signaling to reconfigure the UE each time a change is made. Therefore, aspects can reduce latency and help to maintain continuity of service between a network and a UE.

At 902, the MN receives from one or more target SNs, a set of candidate target PSCells, each PSCell in the set associated with a first SCG configuration. FIGS. 4-7 illustrate various example aspects of an MN receiving a set of target PSCells from one or more target SNs.

At 904, the MN provides, to a UE, a first MCG configuration and a first SCG configuration.

At 906, the MN provides, to the UE, a set of conditional SCG configurations, each conditional SCG configuration including a combined set of candidate target PSCells, corresponding PSCell change execution conditions, and corresponding SCG configurations, the combined set of candidate target PSCells being based on the set of candidate target PSCells received from the one or more target SNs. FIGS. 4-7 illustrate various example aspects of a MN providing a multi-SCG configuration to a UE.

The MN may further send a message to a source SN to retrieve the first SCG configuration; receive the first SCG configuration from the source SN; and send, prior to receiving the set of candidate target PSCells, an SN addition request to the one or more target SNs including the first SCG configuration received from the source SN.

In some aspects, the MN may receive, from a source SN, an SN change indication and the first SCG configuration; and send, prior to receiving the set of candidate target PSCells, an SN addition request to the one or more target SNs including the first SCG configuration received from the source SN.

The set of conditional SCG configurations may include, for each candidate target PSCell, an additional MCG configuration and an additional SCG configuration to be applied when the UE accesses the candidate target PSCell, wherein the additional MCG configuration and the additional SCG configuration indicate a delta relative to the first MCG configuration and the first SCG configuration. In some aspects, the set of conditional SCG configurations may be received in an SN addition request ACK message that indicates that the additional SCG configuration is a delta with respect to the first MCG configuration and the first SCG configuration.

Each PSCell change execution condition may be indicated by a measurement identifier with respect to a source MCG measurement configuration.

For each given candidate target PSCell indicated at a first level, the set of conditional SCG configurations may include a group of candidate target PSCells, one or more PSCell change execution conditions corresponding to a candidate target PSCell from the group of candidate target PSCells, a group of MCG configurations, and a group of SCG configurations for the UE to apply when the UE changes to the candidate target PSCell from the group of candidate target PSCells.

The MN may indicate to the UE to maintain the first MCG configuration, the first SCG configuration, and the set of conditional SCG configurations after a PSCell change. In some aspects, the set of conditional SCG configurations may include a set of IDs for security key derivation, in which one ID is associated with each PSCell change of the UE. In some aspects, the set of conditional SCG configurations may include a set of key counters with a key counter associated with each PSCell change. The MN may send, to a target SN, a set of SN keys including an SN key associated with each PSCell change of the UE.

In some aspects, the MN may send an initial SCG configuration to a first target SN in an SN addition request; receive a second SCG configuration from the first target SN; and provide the second SCG configuration to a subsequent target SN in a subsequent SN addition request.

The method may further include any of the aspects performed by the source MN in FIG. 4, 5, 6, and/or 7.

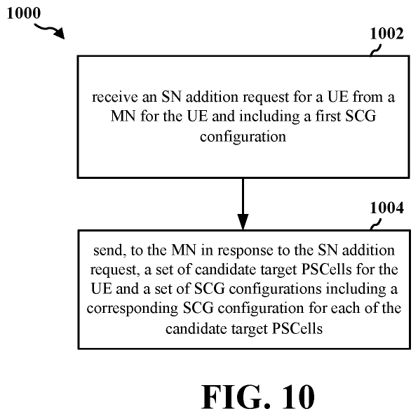

FIG. 10 is a flowchart 1000 of a method of wireless communication. The method may be performed by a network node, such as an SN (e.g., the base station 102, 310; source SN 406, 506, 606; target SN 408, 508 608, 610, 706, 708; the network entity 1202. Aspects may be performed by a network node that may correspond to a base station in aggregation and/or by one or more components of a base station, such as a CU 110, DU 130 and/or RU140. Various aspects of the method may be performed, e.g., by the multi-SCG component 199 described in connection with FIG. 1, 3, and/or 12. The method helps to improve mobility for a UE by providing information to enable the UE to perform a sequence of PSCell changes without signaling to reconfigure the UE each time a change is made. Therefore, aspects can reduce latency and help to maintain continuity of service between a network and a UE.

At 1002, the SN receives an SN addition request for a UE from an MN for the UE and including a first SCG configuration. FIGS. 4-7 illustrate various example aspects of an SN receiving a request for SCG configurations

At 1004, the SN sends, to the MN in response to the SN addition request, a set of candidate target PSCells for the UE and a set of SCG configurations including a corresponding SCG configuration for each of the candidate target PSCells. Each SCG configuration may indicate a delta relative to the first SCG configuration.

In some aspects, the SN may send, prior to receiving the SN addition request, an SN change indication to the MN with the first SCG configuration. The SN change indication may include one or more of: a target SN ID for a first and each subsequent PSCell change, a candidate PSCell ID for the first and each subsequent PSCell change, PSCell change execution conditions for the first and each subsequent PSCell change, an indication of a selective activation procedure, or a combination thereof.

In some aspects, the SN may provide, as a source SN, updated execution conditions to the MN after receiving information regarding the candidate target PSCells prepared by one or more target SNs.

In some aspects, the SN may receive a message from the UE to access the SN and indicating an ID associated with a PSCell change of the UE and communicate with the UE using a security key derived based in part on the ID.

The method may further include any of the aspects performed by an SN in FIG. 4, 5, 6, and/or 7.

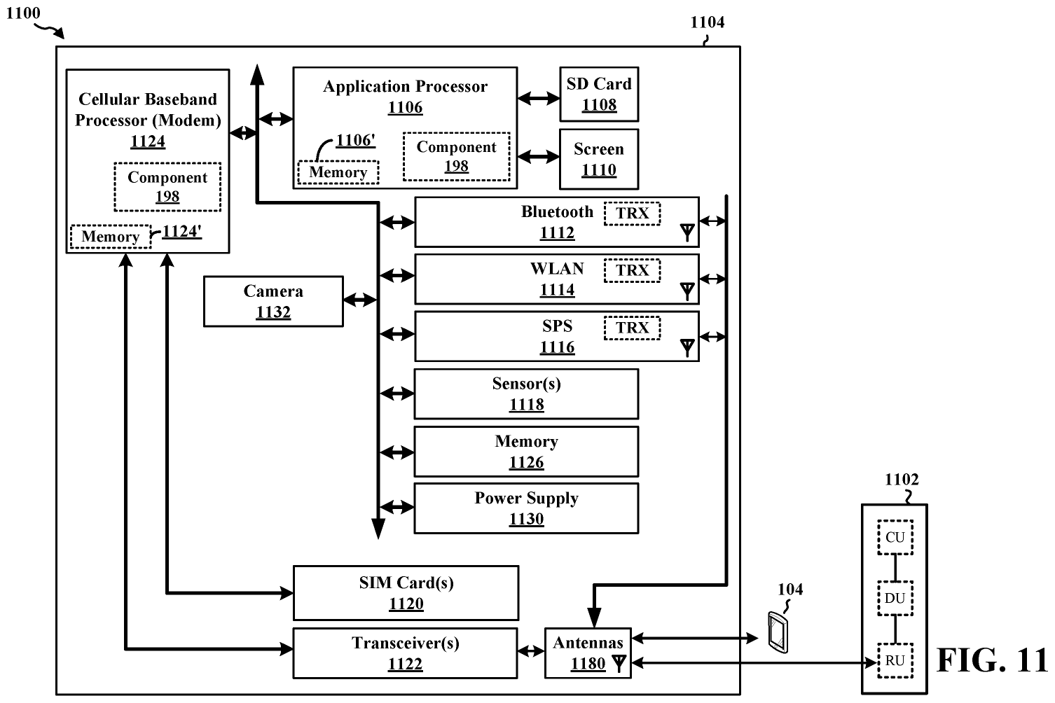

FIG. 11 is a diagram 1100 illustrating an example of a hardware implementation for an apparatus 1104. The apparatus 1104 may be a UE, a component of a UE, or may implement UE functionality. In some aspects, the apparatus 1104 may include at least one cellular baseband processor 1124 (or processor circuitry) (also referred to as a modem) coupled to one or more transceivers 1122 (e.g., cellular RF transceiver). The cellular baseband processor 1124 may include at least one on-chip memory 1124′ (or memory circuitry). In some aspects, the apparatus 1104 may further include one or more subscriber identity modules (SIM) cards 1120 and at least one application processor 1106 (or processor circuitry) coupled to a secure digital (SD) card 1108 and a screen 1110. The application processor 1106 may include at least one on-chip memory 1106′ (or memory circuitry). In some aspects, the apparatus 1104 may further include a Bluetooth module 1112, a WLAN module 1114, an SPS module 1116 (e.g., GNSS module), one or more sensor modules 1118 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1126, a power supply 1130, and/or a camera 1132. The Bluetooth module 1112, the WLAN module 1114, and the SPS module 1116 may include an on-chip transceiver (TRX) (or in some cases, just a receiver (RX)). The Bluetooth module 1112, the WLAN module 1114, and the SPS module 1116 may include their own dedicated antennas and/or utilize the antennas 1180 for communication. The cellular baseband processor 1124 communicates through the transceiver(s) 1122 via one or more antennas 1180 with the UE 104 and/or with an RU associated with a network entity 1102. The cellular baseband processor 1124 and the application processor 1106 may each include a computer-readable medium/memory 1124′, 1106′, respectively. The additional memory modules 1126 may also be considered a computer-readable medium/memory. Each computer-readable medium/memory 1124′, 1106′, 1126 may be non-transitory. The cellular baseband processor 1124 and the application processor 1106 are each responsible for general processing, including the execution of software stored on the computer-readable medium/memory. The software, when executed by the cellular baseband processor 1124/application processor 1106, causes the cellular baseband processor 1124/application processor 1106 to perform the various functions described supra. The cellular baseband processor(s) 1124 and the application processor(s) 1106 are configured to perform the various functions described supra based at least in part of the information stored in the memory. That is, the cellular baseband processor(s) 1124 and the application processor(s) 1106 may be configured to perform a first subset of the various functions described supra without information stored in the memory and may be configured to perform a second subset of the various functions described supra based on the information stored in the memory. The computer-readable medium/memory may also be used for storing data that is manipulated by the cellular baseband processor 1124/application processor 1106 when executing software. The cellular baseband processor 1124/application processor 1106 may be a component of the UE 350 and may include the memory 360 and/or at least one of the TX processor 368, the RX processor 356, and the controller/processor 359. In one configuration, the apparatus 1104 may be a processor chip (modem and/or application) and include just the cellular baseband processor 1124 and/or the application processor 1106, and in another configuration, the apparatus 1104 may be the entire UE (e.g., see 350 of FIG. 3) and include the additional modules of the apparatus 1104.

As discussed supra, the component 198 is configured to perform the method described in connection with the flowchart in FIG. 8 and/or the aspects performed by the UE in any of FIGS. 4-7. For example, the component 198 may be configured to cause the apparatus to receive a first MCG configuration and a first SCG configuration; receive a set of conditional SCG configurations, each conditional SCG configuration including a set of candidate target PSCells, corresponding PSCell change execution conditions, and corresponding SCG configurations; and communicate with a network, in response to an PSCell change execution condition corresponding to a first PSCell being satisfied, based on the first MCG configuration, the first SCG configuration, and an SCG configuration corresponding to the first PSCell. The component 198 may be further configured to evaluate, following a change to a candidate target PSCell at the first level, the group of candidate target PSCells and the one or more PSCell change execution conditions corresponding to the candidate target PSCell. The component 198 may be further configured to maintain the first MCG configuration, the first SCG configuration, and the set of conditional SCG configurations after a PSCell change. The component 198 may be further configured to receive a command for a PSCell change while evaluating the corresponding PSCell change execution conditions; perform the PSCell change in response to the command; and maintain the first MCG configuration, the first SCG configuration, and the set of conditional SCG configurations after performing the PSCell change. The component 198 may be further configured to receive a command to release an SCG while evaluating the PSCell change execution conditions from the set of conditional SCG configurations; and discard the first SCG configuration and the set of conditional SCG configurations in response to the command. The component 198 may be further configured to provide a corresponding ID to a target SN associated with the first PSCell in response to a change to the first PSCell; and use a key derived based on the corresponding ID for communicating with the first PSCell. The component 198 may be further configured to use a key derived based on the key counter associated with a PSCell change to the first PSCell for communicating with the first PSCell. The component 198 may be within the cellular baseband processor 1124, the application processor 1106, or both the cellular baseband processor 1124 and the application processor 1106. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 1104 may include a variety of components configured for various functions. In one configuration, the apparatus 1104, and in particular the cellular baseband processor 1124 and/or the application processor 1106, includes means for performing the method described in connection with the flowchart in FIG. 8 and/or the aspects performed by the UE in any of FIGS. 4-7. For example, the apparatus 1104 may include means for receiving a first MCG configuration and a first SCG configuration; means for receiving a set of conditional SCG configurations, each conditional SCG configuration including a set of candidate target PSCells, corresponding PSCell change execution conditions, and corresponding subsequent SCG configurations; and means for communicating with a network, in response to an PSCell change execution condition corresponding to a first PSCell being satisfied, based on the first MCG configuration, the first SCG configuration, and an SCG configuration corresponding to the first PSCell. The apparatus 1104 may further include means for evaluating, following a change to a candidate target PSCell at the first level, the group of candidate target PSCells and the one or more PSCell change execution conditions corresponding to the candidate target PSCell. The apparatus 1104 may further include means for maintaining the first MCG configuration, the first SCG configuration, and the set of conditional SCG configurations after a PSCell change. The apparatus 1104 may further include means for receiving a command for a PSCell change while evaluating the corresponding PSCell change execution conditions; means for performing the PSCell change in response to the command; and means for maintaining the first MCG configuration, the first SCG configuration, and the set of conditional SCG configurations after performing the PSCell change. The apparatus 1104 may further include means for receiving a command to release an SCG while evaluating the PSCell change execution conditions from the set of conditional SCG configurations; and means for discarding the first SCG configuration and the set of conditional SCG configurations in response to the command. The apparatus 1104 may further include means for providing a corresponding ID to a target SN associated with the first PSCell in response to a change to the first PSCell; and means for using a key derived based on the corresponding ID for communicating with the first PSCell. The apparatus 1104 may further include means for using a key derived based on the key counter associated with a PSCell change to the first PSCell for communicating with the first PSCell. The means may be the component 198 of the apparatus 1104 configured to perform the functions recited by the means. As described supra, the apparatus 1104 may include the TX processor 368, the RX processor 356, and the controller/processor 359. As such, in one configuration, the means may be the TX processor 368, the RX processor 356, and/or the controller/processor 359 configured to perform the functions recited by the means.

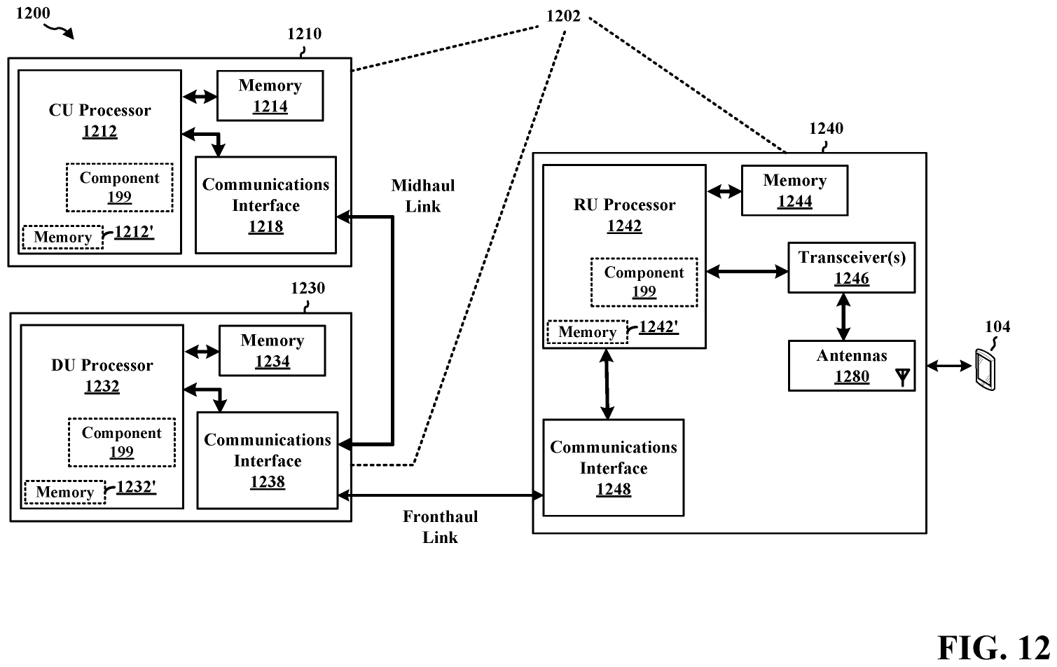

FIG. 12 is a diagram 1200 illustrating an example of a hardware implementation for a network entity 1202. The network entity 1202 may be a BS, a component of a BS, or may implement BS functionality. The network entity 1202 may include at least one of a CU 1210, a DU 1230, or an RU 1240. For example, depending on the layer functionality handled by the component 199, the network entity 1202 may include the CU 1210; both the CU 1210 and the DU 1230; each of the CU 1210, the DU 1230, and the RU 1240; the DU 1230; both the DU 1230 and the RU 1240; or the RU 1240. The CU 1210 may include at least one CU processor 1212 (or processor circuitry). The CU processor 1212 may include on-chip memory 1212′ (or memory circuitry). In some aspects, the CU 1210 may further include additional memory modules 1214 and a communications interface 1218. The CU 1210 communicates with the DU 1230 through a midhaul link, such as an F1 interface. The DU 1230 may include at least one DU processor 1232 (or processor circuitry). The DU processor 1232 may include on-chip memory 1232′ (or memory circuitry). In some aspects, the DU 1230 may further include additional memory modules 1234 and a communications interface 1238. The DU 1230 communicates with the RU 1240 through a fronthaul link. The RU 1240 may include at least one RU processor 1242 (or processor circuitry). The RU processor 1242 may include on-chip memory 1242′ (or memory circuitry). In some aspects, the RU 1240 may further include additional memory modules 1244, one or more transceivers 1246, antennas 1280, and a communications interface 1248. The RU 1240 communicates with the UE 104. The on-chip memory 1212′, 1232′, 1242′ and the additional memory modules 1214, 1234, 1244 may each be considered a computer-readable medium/memory. Each computer-readable medium/memory may be non-transitory. Each of the processors 1212, 1232, 1242 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the component 199 is configured to the method described in connection with the flowcharts in FIG. 9 and/or 10 and/or the aspects performed by the MN or the SN in any of FIGS. 4-7. For example, in some aspects, the network entity may operate as a MN, and the component 199 may be configured to cause the network entity to receive from one or more target SNs, a set of candidate target PSCells, each PSCell in the set associated with a first SCG configuration; provide, to a UE, a first MCG configuration and a first SCG configuration; and provide, to the UE, a set of conditional SCG configurations, each conditional SCG configuration including a combined set of candidate target PSCells, corresponding PSCell change execution conditions, and corresponding SCG configurations, the combined set of candidate target PSCells being based on the set of candidate target PSCells received from the one or more target SNs. The component 199 may be further configured to send a message to a source SN to retrieve the first SCG configuration; receive the first SCG configuration from the source SN; and send, prior to receiving the set of candidate target PSCells, an SN addition request to the one or more target SNs including the first SCG configuration received from the source SN. The component 199 may be further configured to receive, from a source SN, an SN change indication and the first SCG configuration; and send, prior to receiving the set of candidate target PSCells, an SN addition request to the one or more target SNs including the first SCG configuration received from the source SN. The component 199 may be further configured to indicate to the UE to maintain the first MCG configuration, the first SCG configuration, and the set of conditional SCG configurations after a PSCell change. The component 199 may be further configured to send to a target SN, a set of SN keys including an SN key associated with each PSCell change of the UE. The component 199 may be further configured to send an initial SCG configuration to a first target SN in an SN addition request; receive a second SCG configuration from the first target SN; and provide the second SCG configuration to a subsequent target SN in a subsequent SN addition request. In some aspects, the network entity may operate as an SN, and the component 199 may be configured to receive an SN addition request for a UE from a MN for the UE and including a first SCG configuration; and send, to the MN in response to the SN addition request, a set of candidate target PSCells for the UE and a set of SCG configurations including a corresponding SCG configuration for each of the candidate target PSCells. The component 199 may be further configured to send, prior to receiving the SN addition request, an SN change indication to the MN with the first SCG configuration. The component 199 may be further configured to provide, as a source SN, updated execution conditions to the MN after receiving information regarding the candidate target PSCells prepared by one or more target SNs. The component 199 may be further configured to receive a message from the UE to access the SN and indicating an ID associated with a PSCell change of the UE; and communicate with the UE using a security key derived based in part on the ID. The component 199 may be within one or more processors of one or more of the CU 1210, DU 1230, and the RU 1240. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 1202 may include a variety of components configured for various functions. In one configuration, the network entity 1202 includes means for performing the method described in connection with the flowcharts in FIG. 9 and/or 10 and/or the aspects performed by the MN or the SN in any of FIGS. 4-7. For example, the network entity 1202 may operate as a MN, at times, and may include means for receiving from one or more target SNs, a set of candidate target PSCells, each PSCell in the set associated with a first SCG configuration; means for providing, to a UE, a first MCG configuration and a first SCG configuration; and means for providing, to the UE, a set of conditional SCG configurations, each conditional SCG configuration including a combined set of candidate target PSCells, corresponding PSCell change execution conditions, and corresponding SCG configurations, the combined set of candidate target PSCells being based on the set of candidate target PSCells received from the one or more target SNs. The network entity 1202 may further include means for sending a message to a source SN to retrieve the first SCG configuration; include means for receiving the first SCG configuration from the source SN; and means for sending, prior to receiving the set of candidate target PSCells, an SN addition request to the one or more target SNs including the first. SCG configuration received from the source SN. The network entity 1202 may further include means for receiving, from a source SN, an SN change indication and the first SCG configuration; and means for sending, prior to receiving the set of candidate target PSCells, an SN addition request to the one or more target SNs including the first SCG configuration received from the source SN. The network entity 1202 may further include means for indicating to the UE to maintain the first MCG configuration, the first SCG configuration, and the set of conditional SCG configurations after a PSCell change. The network entity 1202 may further include means for sending to a target SN, a set of SN keys including an SN key associated with each PSCell change of the UE. The network entity 1202 may further include means for sending an initial SCG configuration to a first target SN in an SN addition request; means for receiving a second SCG configuration from the first target SN; and means for providing the second SCG configuration to a subsequent target SN in a subsequent SN addition request. In some aspects, the network entity 1202 may operate as an SN, and may include means for receiving an SN addition request for a UE from a MN for the UE and including a first SCG configuration; and means for sending, to the MN in response to the SN addition request, a set of candidate target PSCells for the UE and a set of SCG configurations including a corresponding SCG configuration for each of the candidate target PSCells. The network entity 1202 may further include means for sending, prior to receiving the SN addition request, an SN change indication to the MN with the first SCG configuration. The network entity 1202 may further include means for providing, as a source SN, updated execution conditions to the MN after receiving information regarding the candidate target PSCells prepared by one or more target SNs. The network entity 1202 may further include means for receiving a message from the UE to access the SN and indicating an ID associated with a PSCell change of the UE; and means for communicating with the UE using a security key derived based in part on the ID The means may be the component 199 of the network entity 1202 configured to perform the functions recited by the means. As described supra, the network entity 1202 may include the TX processor 316, the RX processor 370, and the controller/processor 375. As such, in one configuration, the means may be the TX processor 316, the RX processor 370, and/or the controller/processor 375 configured to perform the functions recited by the means.

It is understood that the specific order or hierarchy of blocks in the processes / flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor is configured to perform a set of functions, the at least one processor, individually or in any combination, is configured to perform the set of functions. Accordingly, each processor of the at least one processor may be configured to perform a particular subset of the set of functions, where the subset is the full set, a proper subset of the set, or an empty subset of the set. If a first apparatus receives data from or transmits data to a second apparatus, the data may be received/transmitted directly between the first and second apparatuses, or indirectly between the first and second apparatuses through a set of apparatuses. A device configured to “output” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a UE, comprising: receiving a first MCG configuration and a first SCG configuration; receiving a set of conditional SCG configurations, each conditional SCG configuration including a set of candidate target primary secondary cells (PSCells), corresponding PSCell change execution conditions, and corresponding SCG configurations; and communicating with a network, in response to an PSCell change execution condition corresponding to a first PSCell being satisfied, based on the first MCG configuration, the first SCG configuration, and an SCG configuration corresponding to the first PSCell.

In aspect 2, the method of aspect 1 further includes that the set of conditional SCG configurations includes an associated MCG configuration and an associated SCG configuration for each candidate target PSCell, which indicates a delta relative to the first MCG configuration and the first SCG configuration, and wherein communicating based on the first MCG configuration, the first SCG configuration, and the SCG configuration corresponding to the first PSCell comprises applying the delta relative to the first MCG configuration and the first SCG configuration.

In aspect 3, the method of aspect 1 or aspect 2 further includes that the first SCG configuration is received from a source SN via an MN, and the SCG configuration corresponding to a candidate target PSCell is provided to the UE in the set of conditional SCG configurations from a target SN via the MN.

In aspect 4, the method of any of aspects 1-3 further includes that each PSCell change execution condition is indicated by a measurement identifier with respect to a source MCG measurement configuration.

In aspect 5, the method of any of aspects 1-4 further includes that for each given candidate target PSCell indicated at a first level, the set of conditional SCG configurations further includes: a group of candidate target PSCells, one or more PSCell change execution conditions corresponding to a candidate target PSCell from the group of candidate target PSCells, a group of MCG configurations, and a group of SCG configurations for the UE to apply when the UE changes to the candidate target PSCell from the group of candidate target PSCells.

In aspect 6, the method of aspect 5 further includes evaluating, following a change to the candidate target PSCell from the group of candidate target PSCells, an additional group of candidate target PSCells and the one or more PSCell change execution conditions corresponding to an additional candidate target PSCell from the additional group of candidate target PSCells.

In aspect 7, the method of any of aspects 1-6 further includes maintaining the first MCG configuration, the first SCG configuration, and the set of conditional SCG configurations after a PSCell change.

In aspect 8, the method of any of aspects 1-7, further including receiving a command for a PSCell change while evaluating the corresponding PSCell change execution conditions; performing the PSCell change in response to the command; and maintaining the first MCG configuration, the first SCG configuration, and the set of conditional SCG configurations after performing the PSCell change.

In aspect 9, the method of aspect 8 further includes that the command includes an indication to maintain the first MCG configuration, the first SCG configuration, and the set of conditional SCG configurations after performing the PSCell change.

In aspect 10, the method of any of aspects 1-6 further includes receiving a command from the network to release an SCG while evaluating one or more PSCell change execution conditions from the set of conditional SCG configurations; and discarding the first SCG configuration and the set of conditional SCG configurations in response to the command.

In aspect 11, the method of any of aspects 1-10 further includes that the set of conditional SCG configurations further includes a set of IDs with one ID associated with each PSCell change, the method further comprising: providing a corresponding ID to a target SN associated with the first PSCell in response to a change to the first PSCell; and using a key derived based on the corresponding ID for communicating with the first PSCell.

In aspect 12, the method of any of aspects 1-10 further includes that the set of conditional SCG configurations includes a set of key counters with a key counter associated with each PSCell change, the method further comprising: using a key derived based on the key counter associated with a PSCell change to the first PSCell for communicating with the first PSCell.

Aspect 13 is an apparatus for wireless communication at a UE, comprising: at least one memory; and at least one processor coupled to the at least one memory and, based at least in part on information stored in the at least one memory, the at least one processor, individually or in any combination, is configured to cause the UE to perform the method of any of aspects 1-12.

Aspect 14 is an apparatus for wireless communication at a UE, comprising: at least one memory; and at least one processor coupled to the at least one memory and the at least one processor, individually or in any combination, is configured to perform the method of any of aspects 1-12.

Aspect 15 is an apparatus for wireless communication at a UE, comprising means for performing each step in the method of any of aspects 1-12.

Aspect 16 is the apparatus of any of aspects 13-15, further comprising a transceiver configured to receive or to transmit in association with the method of any of aspects 1-12.

Aspect 17 is a computer-readable medium storing computer executable code at a UE, the code when executed by at least one processor causes the UE to perform the method of any of aspects 1-12.

Aspect 18 is a method of wireless communication at an MN, comprising: receiving from one or more target SNs, a set of candidate target PSCells, each PSCell in the set associated with a first SCG configuration; providing, to a UE, a first MCG configuration and a first SCG configuration; and providing, to the UE, a set of conditional SCG configurations, each conditional SCG configuration including a combined set of candidate target PSCells, corresponding PSCell change execution conditions, and corresponding SCG configurations, the combined set of candidate target PSCells being based on the set of candidate target PSCells received from the one or more target SNs.

In aspect 19, the method of aspect 18 further includes sending a message to a source SN to retrieve the first SCG configuration; receiving the first SCG configuration from the source SN; and sending, prior to receiving the set of candidate target PSCells, an SN addition request to the one or more target SNs including the first SCG configuration received from the source SN.

In aspect 20, the method of aspect 18 further includes receiving, from a source SN, an SN change indication and the first SCG configuration; and sending, prior to receiving the set of candidate target PSCells, an SN addition request to the one or more target SNs including the first SCG configuration received from the source SN.

In aspect 21, the method of any of aspects 18-20 further includes that the set of conditional SCG configurations includes, for each candidate target PSCell, an additional MCG configuration and an additional SCG configuration to be applied when the UE accesses the candidate target PSCell, wherein the additional MCG configuration and the additional SCG configuration indicate a delta relative to the first MCG configuration and the first SCG configuration.

In aspect 22, the method of aspect 21 further includes that the set of conditional SCG configurations are received in an SN addition request ACK message that indicates that the additional SCG configuration is the delta with respect to the first MCG configuration and the first SCG configuration.

In aspect 23, the method of any of aspects 18-22 further includes that each PSCell change execution condition is indicated by a measurement identifier with respect to a source MCG measurement configuration.

In aspect 24, the method of any of aspects 18-23 further includes that for each given candidate target PSCell indicated at a first level, the set of conditional SCG configurations further includes: a group of candidate target PSCells, one or more PSCell change execution conditions corresponding to a candidate target PSCell from the group of candidate target PSCells, a group of MCG configurations, and a group of SCG configurations for the UE to apply when the UE changes to the candidate target PSCell from the group of candidate target PSCells.

In aspect 25, the method of any of aspects 24 further includes indicating to the UE to maintain the first MCG configuration, the first SCG configuration, and the set of conditional SCG configurations after a PSCell change.

In aspect 26, the method of any of aspects 18-25 further includes that the set of conditional SCG configurations further includes a set of IDs for security key derivation, in which one ID is associated with each PSCell change of the UE.

In aspect 27, the method of any of aspects 18-25 further includes that the set of conditional SCG configurations includes a set of key counters with a key counter associated with each PSCell change.

In aspect 28, the method of aspect 27 further includes sending to a target SN, a set of SN keys including an SN key associated with each PSCell change of the UE.

In aspect 29, the method of any of aspects 18-28 further includes sending an initial SCG configuration to a first target SN in an SN addition request; receiving a second SCG configuration from the first target SN; and providing the second SCG configuration to a subsequent target SN in a subsequent SN addition request.

Aspect 30 is an apparatus for wireless communication at an MN, comprising: at least one memory; and at least one processor coupled to the at least one memory and, based at least in part on information stored in the at least one memory, the at least one processor, individually or in any combination, is configured to cause the MN to perform the method of any of aspects 18-29.

Aspect 31 is an apparatus for wireless communication at a MN, comprising: at least one memory; and at least one processor coupled to the at least one memory and the at least one processor, individually or in any combination, is configured to perform the method of any of aspects 18-29.

Aspect 32 is an apparatus for wireless communication at a MN, comprising means for performing each step in the method of any of aspects 18-29.

Aspect 33 is the apparatus of any of aspects 30-23, further comprising a transceiver configured to receive or to transmit in association with the method of any of aspects 18-29.

Aspect 34 is a computer-readable medium (e.g., non-transitory) storing computer executable code at an MN, the code when executed by at least one processor causes the MN to perform the method of any of aspects 18-29.

Aspect 35 is a method of wireless communication at an SN, comprising receiving an SN addition request for a UE from an MN for the UE and including a first SCG request, a set of candidate target PSCells for the UE and a set of SCG configurations including a corresponding SCG configuration for each of the candidate target PSCells.

In aspect 36, the method of aspect 35 further includes that each SCG configuration indicates a delta relative to the first SCG configuration.

In aspect 37, the method of aspect 35 or 36, further comprises sending, prior to receiving the SN addition request, an SN change indication to the MN with the first SCG configuration.

In aspect 38, the method of any of aspects 35-37 further includes that the SN change indication includes one or more of: a target SN identifier (ID) for a first and each subsequent PSCell change, a candidate PSCell ID for the first and each subsequent PSCell change, PSCell change execution conditions for the first and each subsequent PSCell change, an indication of a selective activation procedure, or a combination thereof.

In aspect 39, the method of any of aspects 35-38 further includes providing, as a source SN, updated execution conditions to the MN after receiving information regarding the candidate target PSCells prepared by one or more target SNs.

In aspect 40, the method of any of aspects 35-59 further includes receiving a message from the UE to access the SN and indicating an ID associated with a PSCell change of the UE; and communicating with the UE using a security key derived based in part on the ID.

Aspect 41 is an apparatus for wireless communication at an SN, comprising: at least one memory; and at least one processor coupled to the at least one memory and, based at least in part on stored information that is stored in the at least one memory, the at least one processor, individually or in any combination, is configured to cause the SN to perform the method of any of aspects 35-40.

Aspect 42 is an apparatus for wireless communication at a SN, comprising: at least one memory; and at least one processor coupled to the at least one memory and the at least one processor, individually or in any combination, is configured to perform the method of any of aspects 35-40.

Aspect 43 is an apparatus for wireless communication at a SN, comprising means for performing each step in the method of any of aspects 35-40.

Aspect 44 is the apparatus of any of aspects 41-43, further comprising a transceiver configured to receive or to transmit in association with the method of any of aspects 35-40.

Aspect 45 is a computer-readable medium (e.g., non-transitory) storing computer executable code at SN, the code when executed by at least one processor causes the SN to perform the method of any of aspects 35-40.

What is claimed is:

1. An apparatus for wireless communication at a user equipment (UE), comprising:
at least one memory; and
at least one processor coupled to the at least one memory and, based at least in part on information stored in the at least one memory, the at least one processor, individually or in any combination, is configured to cause the UE to:
receive a first primary cell group (MCG) configuration and a first secondary cell group (SCG) configuration;
receive a set of conditional SCG configurations, each conditional SCG configuration including a set of candidate target primary secondary cells (PSCells), corresponding PSCell change execution conditions, and corresponding SCG configurations; and
communicate with a network, in response to an PSCell change execution condition corresponding to a first PSCell being satisfied, based on the first MCG configuration, the first SCG configuration, and an SCG configuration corresponding to the first PSCell.

2. The apparatus of claim 1, wherein the set of conditional SCG configurations includes an associated MCG configuration and an associated SCG configuration for each candidate target PSCell, which indicates a delta relative to the first MCG configuration and the first SCG configuration, and wherein to communicate based on the first MCG configuration, the first SCG configuration, and the SCG configuration corresponding to the first PSCell, the at least one processor is configured to cause the UE to apply the delta relative to the first MCG configuration and the first SCG configuration.

3. The apparatus of claim 1, wherein the at least one processor is configured to cause the UE to receive the first SCG configuration from a source secondary node (SN) via a primary node (MN), and provide the SCG configuration corresponding to a candidate target PSCell to the UE in the set of conditional SCG configurations from a target SN via the MN.

4. The apparatus of claim 1, wherein each PSCell change execution condition is indicated by a measurement identifier with respect to a source MCG measurement configuration.

5. The apparatus of claim 1, wherein for each given candidate target PSCell indicated at a first level, the set of conditional SCG configurations further includes:
a group of candidate target PSCells,
one or more PSCell change execution conditions corresponding to a candidate target PSCell from the group of candidate target PSCells,
a group of MCG configurations, and
a group of SCG configurations for the UE to apply when the UE changes to the candidate target PSCell from the group of candidate target PSCells.

6. The apparatus of claim 5, wherein the at least one processor is further configured to cause the UE to:
evaluate, following a change to the candidate target PSCell from the group of candidate target PSCells, an additional group of candidate target PSCells and the one or more PSCell change execution conditions corresponding to an additional candidate target PSCell from the additional group of candidate target PSCells.

7. The apparatus of claim 1, wherein the at least one processor is further configured to cause the UE to:
maintain the first MCG configuration, the first SCG configuration, and the set of conditional SCG configurations after a PSCell change.

8. The apparatus of claim 1, wherein the at least one processor is further configured to cause the UE to:
receive a command for a PSCell change while evaluating the corresponding PSCell change execution conditions;
perform the PSCell change in response to the command; and
maintain the first MCG configuration, the first SCG configuration, and the set of conditional SCG configurations after performing the PSCell change.

9. The apparatus of claim 8, wherein the command includes an indication to maintain the first MCG configuration, the first SCG configuration, and the set of conditional SCG configurations after performing the PSCell change.

10. The apparatus of claim 1, wherein the at least one processor is further configured to cause the UE to:
receive a command from the network to release an SCG while evaluating one or more PSCell change execution conditions from the set of conditional SCG configurations; and
discard the first SCG configuration and the set of conditional SCG configurations in response to the command.

11. The apparatus of claim 1, wherein the set of conditional SCG configurations further includes a set of identifiers (IDs) with one ID associated with each PSCell change, and the at least one processor is further configured to cause the UE to:
provide a corresponding ID to a target secondary node (SN) associated with the first PSCell in response to a change to the first PSCell; and
use a key derived based on the corresponding ID for communicating with the first PSCell.

12. The apparatus of claim 1, wherein the set of conditional SCG configurations includes a set of key counters with a key counter associated with each PSCell change, wherein the at least one processor is further configured to cause the UE to:
use a key derived based on the key counter associated with a PSCell change to the first PSCell for communicating with the first PSCell.

13. An apparatus for wireless communication at a primary node (MN), comprising:
at least one memory; and
at least one processor coupled to the at least one memory and, based at least in part on information stored in the at least one memory, the at least one processor, individually or in any combination, is configured to cause the MN to:
receive from one or more target secondary nodes (SNs), a set of candidate target primary secondary cells (PSCells), each PSCell in the set associated with a first secondary cell group (SCG) configuration;
provide, to a user equipment (UE), a first primary cell group (MCG) configuration and a first SCG configuration; and
provide, to the UE, a set of conditional SCG configurations, each conditional SCG configuration including a combined set of candidate target PSCells, corresponding PSCell change execution conditions, and corresponding SCG configurations, the combined set of candidate target PSCells being based on the set of candidate target PSCells received from the one or more target SNs.

14. The apparatus of claim 13, wherein the at least one processor is further configured to cause the MN to:
send a message to a source SN to retrieve the first SCG configuration;
receive the first SCG configuration from the source SN; and
send, prior to receiving the set of candidate target PSCells, an SN addition request to the one or more target SNs including the first SCG configuration received from the source SN.

15. The apparatus of claim 13, wherein the at least one processor is further configured to cause the MN to:
receive, from a source SN, an SN change indication and the first SCG configuration; and
send, prior to receiving the set of candidate target PSCells, an SN addition request to the one or more target SNs including the first SCG configuration received from the source SN.

16. The apparatus of claim 13, wherein the set of conditional SCG configurations includes, for each candidate target PSCell, an additional MCG configuration and an additional SCG configuration to be applied when the UE accesses the candidate target PSCell, wherein the additional MCG configuration and the additional SCG configuration indicate a delta relative to the first MCG configuration and the first SCG configuration.

17. The apparatus of claim 16, wherein the set of conditional SCG configurations are received in an SN addition request acknowledgement (ACK) message that indicates that the additional SCG configuration is the delta with respect to the first MCG configuration and the first SCG configuration.

18. The apparatus of claim 13, wherein each PSCell change execution condition is indicated by a measurement identifier with respect to a source MCG measurement configuration.

19. The apparatus of claim 13, wherein for each given candidate target PSCell indicated at a first level, the set of conditional SCG configurations further includes:
a group of candidate target PSCells,
one or more PSCell change execution conditions corresponding to a candidate target PSCell from the group of candidate target PSCells,
a group of MCG configurations, and
a group of SCG configurations for the UE to apply when the UE changes to the candidate target PSCell from the group of candidate target PSCells.

20. The apparatus of claim 13, wherein the at least one processor is further configured to cause the MN to:
indicate to the UE to maintain the first MCG configuration, the first SCG configuration, and the set of conditional SCG configurations after a PSCell change.

21. The apparatus of claim 13, wherein the set of conditional SCG configurations further includes a set of identifiers (IDs) for security key derivation, in which one ID is associated with each PSCell change of the UE.

22. The apparatus of claim 13, wherein the set of conditional SCG configurations includes a set of key counters with a key counter associated with each PSCell change.

23. The apparatus of claim 22, wherein the at least one processor is further configured to cause the MN to:
send to a target SN, a set of SN keys including an SN key associated with each PSCell change of the UE.

24. The apparatus of claim 13, wherein the at least one processor is further configured to cause the MN to:
send an initial SCG configuration to a first target SN in an SN addition request;
receive a second SCG configuration from the first target SN; and
provide the second SCG configuration to a subsequent target SN in a subsequent SN addition request.

25. An apparatus for wireless communication at a secondary node (SN), comprising:
at least one memory; and
at least one processor coupled to the at least one memory and, based at least in part on stored information that is stored in the at least one memory, the at least one processor, individually or in any combination, is configured to cause the SN to:
receive an SN addition request for a user equipment (UE) from a primary node (MN) for the UE and including a first secondary cell group (SCG) configuration; and
send, to the MN in response to the SN addition request, a set of candidate target primary secondary cells (PSCells) for the UE and a set of SCG configurations including a corresponding SCG configuration for each of the candidate target PSCells.

26. The apparatus of claim 25, wherein each SCG configuration indicates a delta relative to the first SCG configuration.

27. The apparatus of claim 25, wherein the at least one processor is further configured to cause the SN to:
send, prior to receiving the SN addition request, an SN change indication to the MN with the first SCG configuration.

28. The apparatus of claim 27, wherein the SN change indication includes one or more of:
a target SN identifier (ID) for a first and each subsequent PSCell change,
a candidate PSCell ID for the first and each subsequent PSCell change,
PSCell change execution conditions for the first and each subsequent PSCell change,
an indication of a selective activation procedure, or
a combination thereof.

29. The apparatus of claim 25, wherein the at least one processor is further configured to cause the SN to:
provide, as a source SN, updated execution conditions to the MN after receiving information regarding the candidate target PSCells prepared by one or more target SNs.

30. The apparatus of claim 25, wherein the at least one processor is further configured to cause the SN to:
receive a message from the UE to access the SN and indicating an ID associated with a PSCell change of the UE; and
communicate with the UE using a security key derived based in part on the ID.
